(19) United States
(12) Patent Application Publication
(10) Pub. No.: US 2019/0076964 A1
(43) Pub. Date: Mar. 14, 2019

(54) METHOD FOR DETERMINING QUALITY OF HIGH-ENERGY BEAM WELDING, QUALITY DETERMINATION APPARATUS USING THIS DETERMINATION METHOD, AND WELDING MANAGEMENT SYSTEM USING THIS DETERMINATION METHOD

(71) Applicant: HITACHI AUTOMOTIVE SYSTEMS, LTD., Hitachinaka-shi, Ibaraki (JP)

(72) Inventors: Masayuki ICHINOHE, Fujisawa-shi, Kanagawa (JP); Masanori MIYAGI, Hitachinaka-shi, Ibaraki (JP); Tatsuro KUROKI, Isehara-shi, Kanagawa (JP); Xudong ZHANG, Hitachinaka-shi, Ibaraki (JP); Ryo INOUE, Hitachi-shi, Ibaraki` (JP)

(73) Assignee: HITACHI AUTOMOTIVE SYSTEMS, LTD., Hitachinaka-shi, Ibaraki (JP)

(21) Appl. No.: 16/083,843

(22) PCT Filed: Mar. 9, 2017
(86) PCT No.: PCT/JP2017/009468

§ 371 Date: Sep. 10, 2018

(30) Foreign Application Priority Data
Mar. 18, 2016 (JP) 2016-054909

(51) Int. Cl. B23K 31/12; B23K 26/03; B23K 26/046; B23K 26/21

(52) U.S. Cl. CPC B23K 31/125; B23K 26/032; F02M 59/44; B23K 26/21; B23K 26/046

(57) ABSTRACT

An object of the present invention is to, in high-energy beam welding, improve accuracy of determining a welding quality or accuracy of maintaining a certain welding quality by feedback, thereby improving efficiency of manufacturing a welded product, i.e., a yield. One aspect of the present invention acquires an image of a molten pool by a camera, acquires a width, a length, and an area of the molten pool by image processing, further acquires reflected light, plasma, and thermal radiation light by an optical sensor, and carries out a multiple regression analysis with use of the above-described signals and a signal having an interaction effect among them, thereby accurately predicting a weld penetration depth and thus accurately determining the welding quality. Along therewith, the one aspect of the present invention also predicts a beam output and a focal position, and performs feedback control on the beam output and the focal position, thereby keeping the beam output and the focal position at appropriate values and thus maintaining the certain welding quality.

### TECHNICAL FIELD

The present invention relates to high-energy beam welding, and, in particular, to a high-energy beam welding method for an automobile component.

### BACKGROUND ART

In recent years, high-energy beam welding has been becoming widely used because of its capability to achieve deeply penetrating welding and realize accurate and high-speed welding compared to conventional arc welding. One of reasons why the high-energy beam welding can achieve the deeply penetrating welding is that a high-energy beam has a high-power density compared to the arc welding or the like. A metal irradiated with the high-energy beam having the high power-density is molten and evaporated instantly. A molten portion is pushed up by a high reaction force due to this evaporation, and a space called a keyhole is created. The high-energy beam can reach as far as an inside of a material via the keyhole, thereby achieving the deeply penetrating welding. Conventionally, a welding quality has been evaluated only by management of welding conditions of all of products or a sampling inspection, and it has been difficult to monitor actual welded states of all of the products. Therefore, a measure taken under the present situation is to improve the welding quality by regularly cleaning a lens and/or regularly confirming the welding conditions. However, as a fundamental measure for improving reliability of the high-energy beam welding, it has been desired to guarantee the qualities of all of the products by monitoring the actual welded states, or prevent or reduce occurrence of a defect by performing feedback control on the welding conditions when the defect likely occurs.

As a measure against such a problem, there is proposed a method that determines a defect by capturing an image of a molten portion with use of a camera and performing image processing on the captured image, as discussed in Japanese Patent Application Public Disclosure No. 2006-43741 (PTL 1). Alternatively, as another method, there is proposed a method that processes and analyzes an image of an image sensor and feeds back a result thereof to an output and a feeding speed of a welding processing machine, as discussed in Japanese Patent Application Public Disclosure No. 2005-14027 (PTL 2).

### CITATION LIST

### Patent Literature

PTL 1: Japanese Patent Application Public Disclosure No. 2006-43741

PTL 2: Japanese Patent Application Public Disclosure No. 2005-14027

### SUMMARY OF INVENTION

### Technical Problem

The method discussed in PTL 1 captures an image of a portion around a molten pool, calculates a width and a length of the molten pool by the image processing, and determines the defect if the value thereof is larger than a threshold value stored in advance. Further, the method discussed in PTL 2 recognizes a size and a shape of a molten pool by the image processing, and immediately analyzes them and feeds back a result thereof to the output and the feeding speed of the welding processing machine. It is deduced that employing these methods for the laser welding allows the welding defect to be determined and the welding quality to be kept even, thereby preventing a welding failure. However, the above-described methods fail to take into sufficient consideration, for example, highly accurate prediction of a weld penetration depth that is most important in a butt joint, thereby involving a drawback to improvement of accuracy of determining the quality or accuracy of maintaining a certain quality by the feedback. This drawback serves as a cause for impeding improvement of manufacturing efficiency, i.e., improvement of a yield.

An object of the present invention is to, in the high-energy beam welding, improve the accuracy of determining the welding quality or the accuracy of maintaining a certain welding quality by the feedback, thereby improving the efficiency of manufacturing a welded product, i.e., the yield.

### Solution to Problem

To achieve the above-described object, a method for determining a quality of high-energy beam welding according to one aspect of the present invention is a method for determining a quality of high-energy beam welding that welds a welding target object by irradiating the welding target object with a high-energy beam. The method for determining the quality of the high-energy beam welding includes acquiring a predicted value of a weld penetration depth of a molten pool based on
shape information of the molten pool that is detected by performing image processing on an image of the molten pool
captured by a camera, welding optical sensor information including plasma light that is detected by a welding optical sensor, and
a partial regression analysis coefficient acquired by carrying out a multiple regression analysis with the weld penetration depth of the molten pool set as an objective variable and the shape information and the welding optical sensor information set as explanatory variables, and determining the quality of the welding by comparing the predicted value and a reference value.

Further, to achieve the above-described object, an apparatus configured to determine a quality of high-energy beam welding according to one aspect of the present invention is an apparatus configured to determine a quality of high-energy beam welding that welds a welding target object by irradiating the welding target object with a high-energy beam.

The apparatus configured to determine the quality of the high-energy beam welding includes
a molten pool shape information detection portion configured to detect shape information of a molten pool by performing image processing on an image of the molten pool that is captured by a camera,
a welding optical sensor configured to detect welding optical sensor information including plasma light,
a partial regression analysis coefficient storage portion configured to store a partial regression analysis coefficient acquired by carrying out a multiple regression analysis with the weld penetration depth of the molten pool set as an objective variable and the shape information and the welding optical sensor information set as explanatory variables,
a predicted value calculation portion configured to acquire a predicted value of the weld penetration depth of the molten pool based on the molten pool shape information, the welding optical sensor information, and the partial regression analysis coefficient, and
a quality determination portion configured to determine the quality of the welding by comparing the predicted value and a reference value.

Further, to achieve the above-described object, a welding management system for high-energy beam welding according to one aspect of the present invention is a welding management system for high-energy beam welding.

The welding management system for high-energy beam welding includes
a high-energy beam irradiation apparatus configured to weld a welding target object by irradiating the welding target object with a high-energy beam,
a camera configured to capture an image of a molten pool,
a molten pool shape information detection portion configured to detect shape information of the molten pool by performing image processing on the image of the molten pool that is captured by the camera,
a welding optical sensor configured to detect welding optical sensor information including plasma light,
a partial regression analysis coefficient storage portion configured to store a partial regression analysis coefficient acquired by carrying out a multiple regression analysis with the weld penetration depth of the molten pool set as an objective variable and the shape information and the welding optical sensor information set as explanatory variables,
a predicted value calculation portion configured to acquire a predicted value of the weld penetration depth of the molten pool based on the molten pool shape information, the welding optical sensor information, and the partial regression analysis coefficient,
a quality determination portion configured to determine a quality of the welding by comparing the predicted value and a reference value, and
a feedback control portion configured to output a correction value for correcting an irradiation condition of the high-energy beam based on a result of the comparison between the predicted value and the reference value and perform feedback control on the high-energy beam output by the high-energy beam irradiation apparatus.

### Advantageous Effects of Invention

According to the present invention, it is possible to improve the accuracy of determining the welding quality or the accuracy of maintaining a certain welding quality by the feedback, thereby improving the efficiency of manufacturing the welded product, i.e., the yield.

### BRIEF DESCRIPTION OF DRAWINGS

FIG. 1 is a schematic view of a laser welding apparatus according to a first embodiment.

FIG. 2 is a schematic view of an image when a welded portion (a molten pool) according to the first embodiment is viewed from a laser irradiation direction.

FIG. 3 is a schematic view of an image when the molten pool is viewed via a galvano scanner according to the first embodiment.

FIG. 4 illustrates an image and a luminance distribution of the molten pool, and an image processing method according to the first embodiment.

FIG. 5 illustrates an improvement effect due to an interaction according to the first embodiment.

FIG. 6 illustrates a relationship between the number of interactions and a prediction error according to the first embodiment.

FIG. 7 illustrates a predicted value and an actually measured value of a weld penetration depth according to the first embodiment.

FIG. 8 illustrates a result of determining a welding quality according to the first embodiment.

FIG. 9 illustrates a feedback control period according to the first embodiment.

FIG. 10 is a flowchart of feedback control according to the first embodiment.

FIG. 11 illustrates an example of a transition of the weld penetration depth at the time of the feedback control according to the first embodiment.

FIG. 12 is a flowchart of feedback control according to a second embodiment.

FIG. 13 is a schematic view of a laser welding apparatus according to a third embodiment.

FIG. 14 is a cross-sectional view illustrating one embodiment of a fuel pump according to the present invention.

FIG. 15 is a cross-sectional view illustrating one embodiment of a fuel injection valve according to the present invention.

### DESCRIPTION OF EMBODIMENTS

In the following description, embodiments of the present invention will be described with reference to the drawings.

### First Embodiment

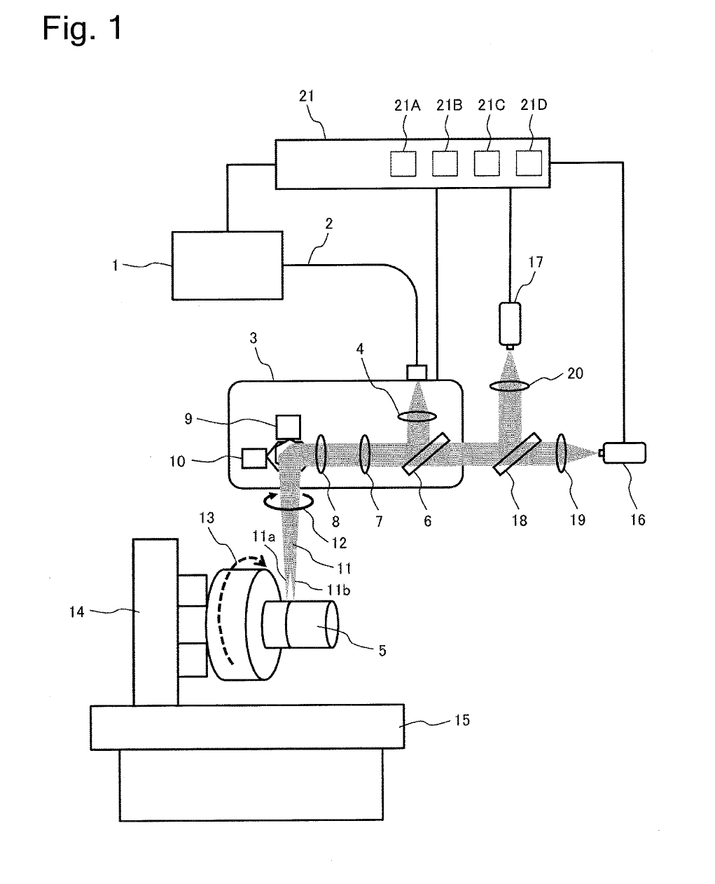

FIG. 1 is a schematic view of a laser welding apparatus according to a first embodiment.

Reference numerals 11, 16, and 17 denote laser, a camera, and a welding optical sensor, respectively. Reference numeral 1 denotes an oscillator, 2 denotes a laser optical fiber, 3 denotes a galvano scanner (a processing head), 4 denotes a collimator lens for widening a beam width in the galvano scanner, 5 denotes a welding target object, 6 denotes a partial wavelength transmissive mirror for transmitting light issued from the welding target object 5 to the camera 16 and the welding optical sensor 17, 7 denotes a Z-axis control lens that controls a position of the laser 11 in a Z axis, 8 denotes an objective lens for collecting the laser 11 having a wide beam width on the welding target object 5, 9 denotes an X-axis control galvano mirror that controls a position of the laser 11 in an X axis, 10 denotes a Y-axis control galvano mirror that controls a position of the laser 11 in a Y axis, 12 denotes a direction in which the laser rotates, 13 denotes a direction in which the welding target object 5 rotates, 14 denotes a rotary spindle, 15 denotes a processing stage, 18 denotes a semi-transmissive mirror that splits the light issued from the welding target object 5 to the camera 16 and the welding optical sensor 17, 19 denotes an objective lens for the camera 16, 20 denotes an objective lens for the welding optical sensor 17, and 21 denotes a control device. The control device processes an image acquired by the camera 16, predicts a weld penetration depth from a combination of the processed image and information from the welding optical sensor 17, and controls the laser oscillator 1 and the galvano scanner 3 based on the predicted weld penetration depth.

In the present embodiment, the welding target object 5 is assumed to be a fuel pump component, and a material thereof is assumed to be 304 stainless steel. Further, the laser 11 is assumed to be a disk laser, a wavelength of which is approximately 1030 nm. A scanning track of the laser 11 is assumed to be circular. FIG. 1 illustrates states of two laser beams 11a and 11b oscillated in a direction perpendicular to a welding progress direction (a direction opposite from the direction in which the welding target object 5 rotates) to make it clear that the scanning track of the laser 11 is circular.

The laser 11 generated by the laser oscillator 1 is transmitted to the galvano scanner 3 via the laser optical fiber 2. The laser 11 is controlled by the X-axis galvano mirror 9 and the Y-axis galvano mirror 10 in terms of its positions in the X axis and the Y axis and then is emitted onto the welding target object 5 while being increased in beam width by the collimator lens 4, reflected by the partial wavelength transmissive mirror 6, controlled in terms of its position in the Z axis by the Z-axis control lens 7, and collected by the objective lens 8. The welding target object 5 is fixed to the rotary spindle 14, and is rotated at a predetermined speed. The light issued from a molten pool of the welding target object 5 enters the camera 16 after passing through the Y-axis galvano mirror 10, the X-axis galvano mirror 9, the objective lens 8, the Z-axis control lens 7, the semi-transmissive mirror 18, and further the objective lens 19 for the camera. Similarly, the light reflected by the semi-transmissive mirror enters the welding optical sensor 17 after passing through the objective lens 20 for the welding optical sensor.

In the present embodiment, the laser welding apparatus will be described, referring to a configuration in a case where a butt joint is created as one example of a welding joint structure.

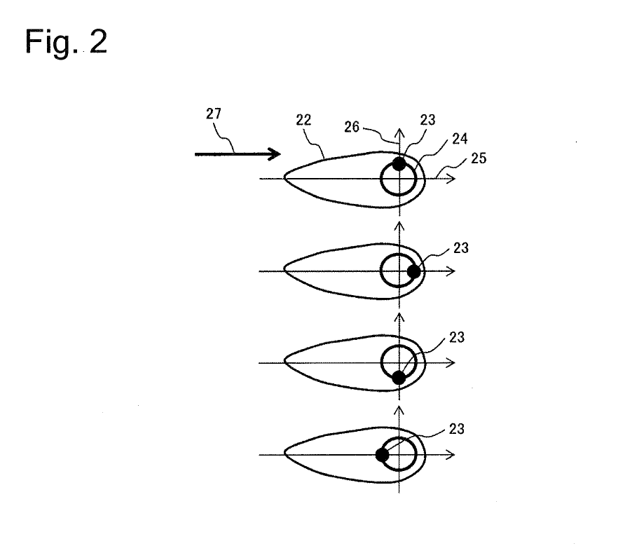

FIG. 2 is a schematic view of an image when a welded portion (the molten pool) according to the first embodiment is viewed from a laser irradiation direction. FIG. 2 illustrates a state (an image) of the molten pool moving in the welding progress direction.

Reference numeral 27 denotes the welding progress direction. Reference numeral 22 denotes the molten pool, 23 denotes a laser irradiation point, 24 denotes a movement track of the laser irradiation point 23 in the molten pool 22, 25 denotes an X axis in the image that coincides with the welding progress direction 27 in a plane (an image) perpendicular to the laser irradiation direction, and 26 denotes a Y axis of the image that coincides with a direction perpendicular to the welding progress direction 27 in the plane (the image) perpendicular to the laser irradiation direction. In the image illustrated in FIG. 2 (hereinafter referred to as an “image as viewed from a viewpoint moving in the welding progress direction 27), the laser irradiation point draws a circular track centered at an origin point of the X axis and Y axis, and a counter of the molten pool 22 is also kept at the same position in X and Y coordinates.

In the present embodiment, the laser welding apparatus can acquire a stable weld penetration depth by irradiating the welding target object while rotating the laser (a high-energy laser beam).

On the other hand, an image in which the laser irradiation point is placed at the origin point is acquired as the image captured by the camera 16 via the galvano scanner 3 illustrated in FIG. 1.

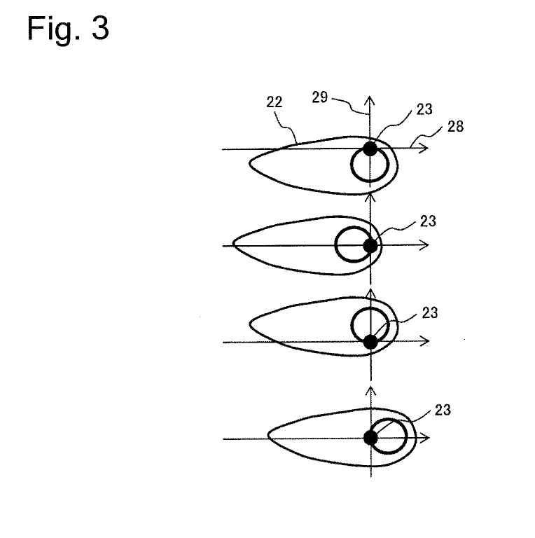

FIG. 3 is a schematic view of the image of the molten pool viewed via the galvano scanner according to the first embodiment. In other words, FIG. 3 illustrates the image of the molten pool in which the laser irradiation point is placed at the origin point.

Reference numeral 23 denotes the laser irradiation point, 28 denotes an X axis of the image in which the laser irradiation point is placed at the origin point, and 29 denotes a Y axis of the image in which the laser irradiation point is placed at the origin point. The X axis extends in parallel with the welding progress direction 27 in the plane (the image) perpendicular to the laser irradiation direction. The Y axis extends perpendicularly to the welding progress direction 27 in the plane (the image) perpendicular to the laser irradiation direction.

In the image in which the laser irradiation point is placed at the origin point, the molten pool rotates around the origin point of the X and Y axes in the acquired image, and it is understood that the contour of the molten pool is located at a different position in the X and Y coordinates. Therefore, in the image as viewed via the galvano scanner 3, the contour of the molten pool 22 cannot be correctly acquired by performing image processing in a region with the X and Y coordinates fixed therein. This raises a necessity of detecting the shape of the molten pool by image processing based on only a change in a luminance without relying on the position.

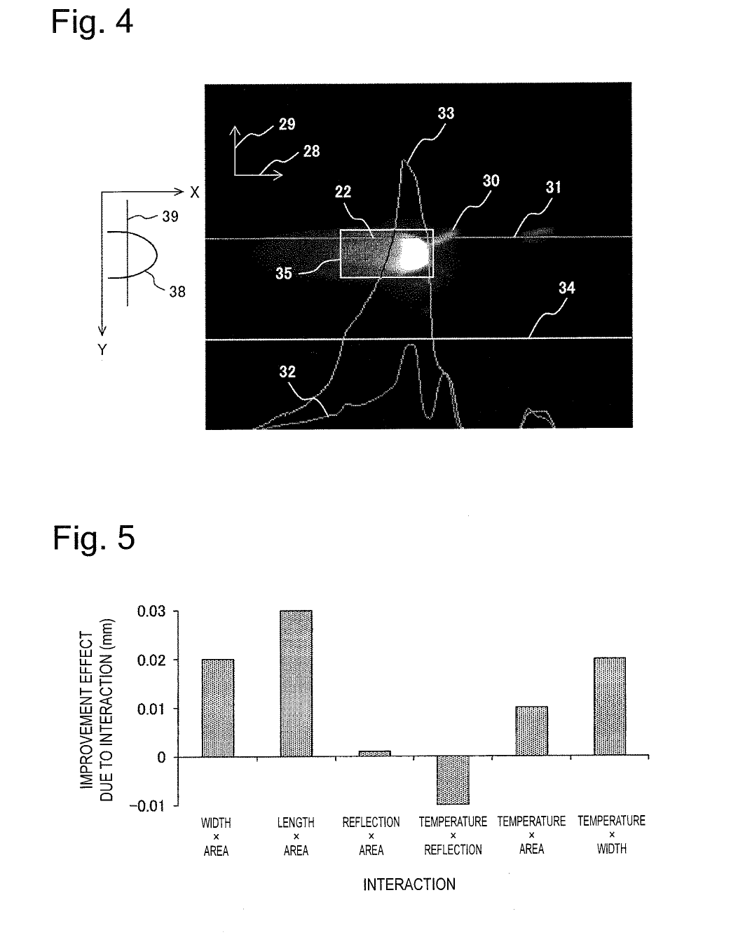

FIG. 4 illustrates an image and a luminance distribution of the molten pool, and an image processing method according to the first embodiment. FIG. 4 also illustrates a method for detecting the shape of the molten pool by the image processing based on only the change in the luminance.

Reference numeral 30 denotes a spatter, 31 denotes a horizontal line on the image in which the luminance is measured, 32 denotes a luminance distribution on the horizontal line 31, 33 denotes a distribution of a value resulting from summing (adding up) luminances on the Y axis 29 (a projection value), 34 denotes a line of a threshold value for detecting a start point and an end point of the molten pool 22 based on the projection value, and 35 denotes a rectangle circumscribed to the molten pool 22 drawn based on the start point and the end point of the molten pool in the X-axis direction and the start point and the end point of the molten pool in the Y-axis direction that are acquired based on this threshold value. The horizontal line 31 extends in parallel with the X axis 28 and the welding progress direction 27.

In the image acquired by the camera 16, not only the molten pool 22 but also the sputter 30 generated at the time of the welding are imaged. Simply binarizing this image results in a failure to separate the sputter and the molten pool, thus unintentionally causing the sputter 30 to be also identified as a part of the molten pool 22 and also included in a length of the molten pool 22. Therefore, a correct length of the molten pool 22 cannot be acquired.

If the contour of the molten pool 22 is constantly located at the same X and Y coordinates, the sputter 30 can be removed by setting a region in which the molten pool 22 exists and identifying a value outside this region as the spatter 30. However, this method cannot be employed for the image as viewed via the galvano scanner 3 because the X and Y coordinates of the counter of the molten pool 22 are changed in this image.

Then, one conceivable method is, for example, to set a threshold value with respect to the luminance distribution 32 on the horizontal line 31 and locate the start point and the end point of the molten pool 22. However, as understood from observation of the luminance distribution 32, the molten pool 22 and the sputter 30 have similar luminance levels to each other, and therefore the sputter 30 cannot be separated.

Therefore, first, the distribution 33 of the value resulting from summing the luminances on the Y axis 29 is acquired. The sputter 30 is narrow in width and therefore has a small value, but the molten pool 22 is wide in width and therefore has a large value. Therefore, setting the threshold value 34 can eliminate the influence of the sputter 30 and allow the start point and the end point of the molten pool 22 to be located. A position of the rectangle 35 circumscribed to the molten pool 22 in the X axis 28 is located in this manner. A position of the rectangle 35 circumscribed to the molten pool 22 in the Y axis 29 is located by acquiring a distribution 38 of a value resulting from summing luminances on the X axis 28 similarly to the luminance distribution 33 on the Y axis 29, and setting a threshold value 39.

Acquired lengths of the rectangle 35 circumscribed to the molten pool 22 in the X axis 28 and the Y axis 29 are determined to be a length and a width of the molten pool 22, respectively. An area is calculated by binarizing an image in this rectangle 35 and confirming a region whited due to the binarization.

The shape of the molten pool can be detected by performing the image processing only on the change in the luminance without locating the position in the image in this manner. This method allows the shape of the molten pool 22 to be detected even in the image as viewed via the galvano scanner 3 that is illustrated in FIG. 3. Further, the use of the projection value allows the shape of the molten pool (shape information of the molten pool or shape data of the molten pool) to be detected with the sputter 30 separated therefrom. By this effect, in the present embodiment, the length, the width, a length/width, and the area of the molten pool can be acquired.

On the other hand, the welding optical sensor 17 can detect information such as plasma light, a temperature (thermal radiation light), and reflected light (welding optical sensor information).

Next, a multiple regression analysis is carried out on data of the weld penetration depth at this time with use of a defocusing distance that is a distance by which a focal point is intentionally shifted in the Z-axis direction from a focal position of the objective lens 8 for collecting the light on the welding target object 5, the shape of the molten pool 22 that is acquired when a welding experiment is conducted while a laser output is oscillated, and the information of the welding optical sensor 17, and partial regression analysis coefficients are acquired regarding these pieces of information and the weld penetration depth. The multiple regression analysis refers to an analysis method that predicts one objective variable from a plurality of explanatory variables, and is expressed by an equation 1.

Y=b1×X1+b2×X2+ . . . +C (1)

In this equation, each of variables represent the following item.
Y: objective variable
X1, X2, . . . : explanatory variable
b1, b2, . . . : partial regression coefficient
C: constant term

In the present embodiment, the objective variable Y is the weld penetration depth, and the explanatory variables X1, X2,. . . are the shape of the molten pool 22 such as the length of the molten pool and the information of the welding optical sensor 17.

The conventional method uses only plasma light as a welding optical sensor signal, and, in this case, the weld penetration depth is predicted at such accuracy that a maximum error is 0.34 mm. In the present embodiment, the temperature (the thermal radiation light), the reflected light, and the like are added as the signal of the welding optical sensor 17, and the maximum error is improved to as small as 0.23 mm by this addition. Further, the maximum error is improved to as small as 0.13 mm by adding an interaction, which is multiplication of two items, as the explanatory variable.

In the present embodiment, the control device 21 forms a molten pool shape information detection portion that detects the shape information of the molten pool 22 by performing the image processing on the image of the molten pool that is captured by the camera 16. Further, the control device 21 forms a predicted value calculation portion 21A that acquires the predicted value of the weld penetration depth of the molten pool 22 by carrying out the multiple regression analysis. Alternatively, the control device 21 includes the predicted value calculation portion 21A that acquires the predicted value of the weld penetration depth of the molten pool 22 by carrying out the multiple regression analysis.

In this manner, in the present embodiment, the laser welding apparatus can acquire an effect of improving the accuracy of determining the welding quality and improving the yield.

FIG. 5 illustrates an improvement effect due to the interaction according to the first embodiment.

The interaction brings about a different improvement effect depending on a combination of the multiplied two items. FIG. 5 illustrates an improvement effect due to each of interactions of the width×the area, the length×the area, the reflection (the reflected light)×the area, the temperature×the reflection, the temperature×the area, and the temperature×the width. In the case of FIG. 5, the length×the area brings about the highest improvement effect, and the temperature×the reflection brings about a minus improvement effect, thereby leading to a change for the worse.

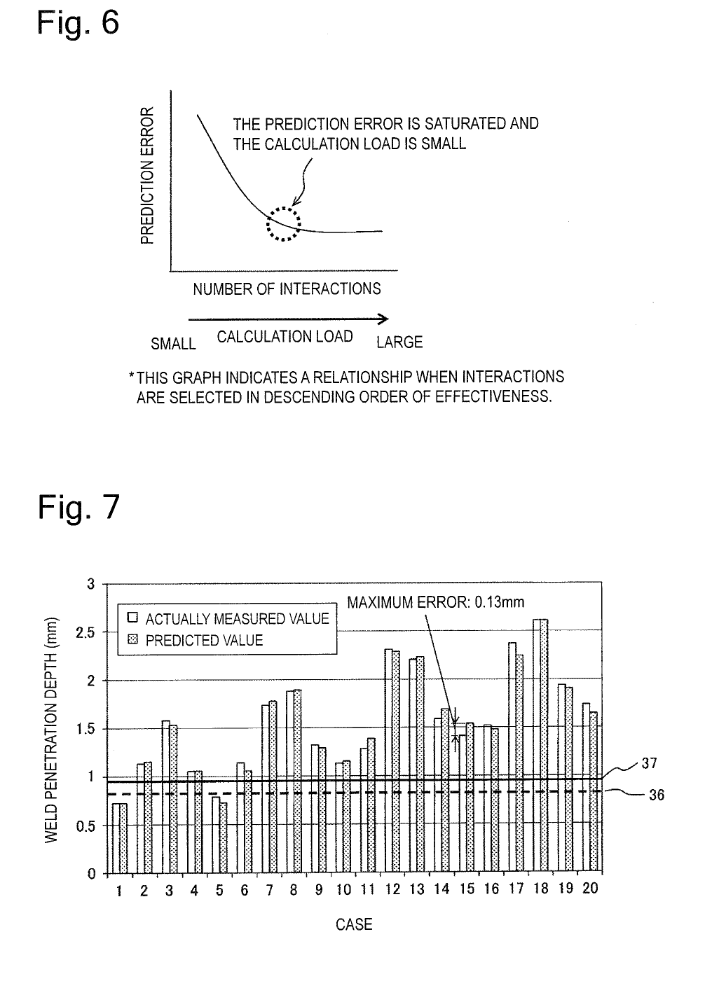

FIG. 6 illustrates a relationship between the number of interactions and a prediction error according to the first embodiment.

When the interactions are selected in such order that a highly effective interaction is placed on the left side, the prediction error reduces as the number of interactions increases, but this change is not linear, and exhibits a sudden reduction first but gradually shifts to a reduction at a gentle gradient. On the other hand, as the number of interactions increases, a calculation load increases. Therefore, there is a point at which the prediction error is saturated and the calculation load is also small as indicated by a circle drawn with a broken line. This point serves as a highly useful point at which the calculation load is not large so match and the prediction error is small.

Therefore, in the present embodiment, variables that lead to a reduction in the prediction error and also lead to a reduction in the calculation load are selected and used as the above-described explanatory variables. By this selection and use, the prediction error can be reduced, and the calculation load can also be reduced. Then, at the time of the feedback control, which will be described below, the welding quality can be improved by feeding back a control amount at a high speed.

FIG. 7 illustrates a predicted value and an actually measured value of a weld penetration depth according to the first embodiment.

FIG. 7 illustrates actually measured values of the weld penetration depth and values thereof predicted by the above-described method under various laser outputs and defocusing distances when the temperature, the plasma, the reflected light, the length of the molten pool, the width of the molten pool, the length/the width of the molten pool, the area of the molten pool, the temperature×the plasma, the temperature×the width, the plasma×the width, and the width×the area were used as the explanatory variables. The weld penetration depth was actually measured and predicted regarding 20 cases from 1 to 20 (20 welding cases). A result thereof indicates that, in the present embodiment, the weld penetration depth can be predicted at high accuracy with the maximum error of 0.13 mm.

Reference numeral 36 denotes a threshold value for determining the welding quality with respect to the actually measured value, and is set to 0.8 mm for the present welded portion. Reference numeral 37 denotes a threshold value for determining the welding with respect to the predicted value in consideration of the maximum error of 0.13 mm, and is set to 0.8+0.13=0.93 mm. The welding quality is determined with use of this threshold value. A welded product is determined to be a satisfactory product (an acceptable product) if a value thereof is the threshold value or larger, and a defective product (a rejectable product) if the value thereof is smaller than the threshold value. This determination is made by the control device 21. In other words, the control device 21 forms a quality determination portion 21B that determines the welding quality. Alternatively, the control device 21 includes the quality determination portion 21B that determines the welding quality. Further, the control device 21 includes a partial regression analysis coefficient storage portion 21C that stores the above-described partial regression analysis coefficients.

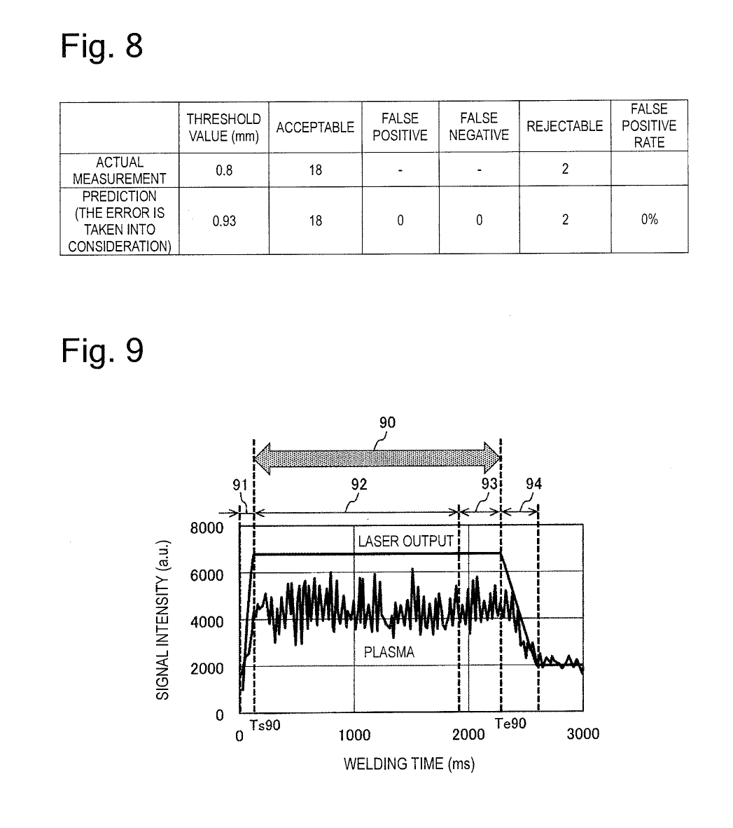

FIG. 8 illustrates a result of determining the welding quality according to the first embodiment.

According to the actually measured value, 18 cases were determined to be acceptable products satisfying or exceeding a threshold value of 0.8 mm, and 2 cases were determined to be rejectable products falling below 0.8 mm. According to the predicted value with the error of 0.13 mm taken into consideration, 18 cases were determined to be acceptable products satisfying or exceeding the threshold value of 0.93 mm, and 2 cases were determined to be rejectable products falling below 0.93 mm. Further, according to this predicted value, both of a false positive, in which the satisfactory product is mistaken as the defective product, and a false negative, in which the defective product is mistaken as the satisfactory product, occurred for zero cases, and a false positive rate was 0%.

Next, the description will continue, focusing on a welding method that prevents the predicted weld penetration depth from falling outside upper and lower limit values by performing the feedback control on the laser output when the predicted weld penetration depth is about to fall outside the set upper and lower limit values.

FIG. 9 illustrates a feedback control period according to the first embodiment.

The laser output includes an upward slope period 91, during which the laser output increases from approximately zero to a laser output for actual welding, an actual welding period 92, a lap portion 93, during which the laser output is overlapped after one complete rotation, and a downward slope period 94, during which the laser output reduces to approximately zero. Among these periods, the feedback control is not performed during the upward slope period 91 and the downward slope period 94 because a signal intensity largely changes and is instable during them. A feedback control period 90 is set to the actual welding period 92 and the lap portion 93, during which the laser output is kept constant.

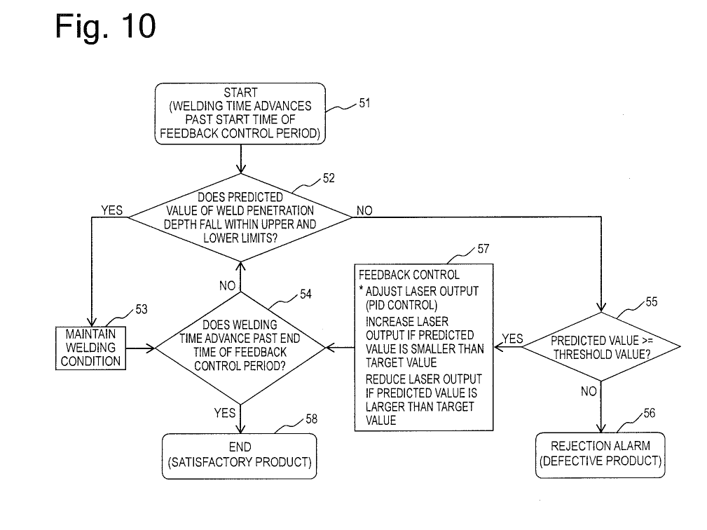

FIG. 10 is a flowchart of the feedback control according to the first embodiment.

In step 51, the flowchart of the feedback control is started when a welding time advances past a start time Ts90 of the feedback control period 90. In step 52, the laser welding apparatus determines whether the predicted value of the weld penetration depth falls within the upper and lower limits. If the determination in step 52 is YES, in step 53, the laser welding apparatus maintains a welding condition. Then, in step 54, the laser welding apparatus determines whether the welding time advances past an end time of the feedback control period. If the determination in step 54 is NO, the processing keeps returning to step 52. If the determination in step 52 is NO, in step 55, the laser welding apparatus determines whether the predicted value is the threshold value or larger. If the determination in step 55 is NO, in step 56, the laser welding apparatus issues a rejection alarm and determines that this product is the defective product. If the determination in step 55 is YES, the laser welding apparatus performs the feedback control. The laser welding apparatus adjusts the laser output by PID control (proportional-integral-differential control), and calculates a correction output value by the following equation.

the correction output value=a previous output value+Kp×a deviation+Ki×a cumulative value of the deviation+Kd×a difference between a present deviation and a previous deviation

In this equation, each of the variables represents the following item.
Kp: proportional control coefficient
Ki: integral control coefficient
Kd: differential control coefficient

At this time, the laser welding apparatus calculates the output value while converting the weld penetration depth into the laser output value from a relational expression between the laser output value and the weld penetration depth that is acquired in advance. By this calculation, the laser welding apparatus increases the laser output when the predicted value is smaller than a target value, and reduces the laser output when the predicted value is larger than the target value. After that, in step 54, the laser welding apparatus determines whether the welding time advances past the end time Te90 of the feedback control period 90. If the determination in step 54 is NO, the processing keeps returning to step 52. If the determination in step 54 is YES, in step 58, the laser welding apparatus ends the feedback control, and determines that the present product is the satisfactory product.

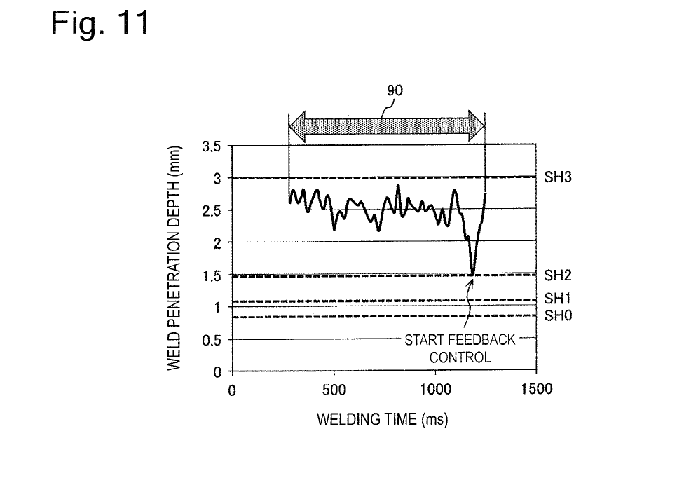

FIG. 11 illustrates an example of a transition of the weld penetration depth at the time of the feedback control according to the first embodiment. FIG. 11 illustrates a specific example of the feedback control.

In FIG. 11, SH0 denotes the threshold value for determining whether the welded product is the acceptable product or the rejectable product, and corresponds to the above-described value, 0.8 mm. In the present embodiment, the threshold value of the predicted value in step 55 is set to a threshold value SH1 having a larger value than SH0. In this case, it is desirable to set the threshold value SH1 of the predicted value to 0.93 mm or larger in consideration of the above-described error, 0.13 mm.

A value SH2 as a lower limit (a lower limit value) for starting the feedback control is set to a larger value than the threshold value SH1. A difference between the threshold value SH1 and the lower limit value SH2 can be appropriately determined by taking into consideration a time lag since when the predicted value of the weld penetration depth falls below the lower limit value until when the effect due to the feedback control starts to appear.

All of the threshold value SH0, the lower limit value SH2, and an upper limit value SH3 are set within an allowable range of the weld penetration depth. Further, the threshold value for determining whether the welded product is the acceptable product or the rejectable product may be set within a numerical range larger than the value SH3 as the upper limit (the upper limit value).

The laser welding apparatus determines whether the predicted value of the weld penetration depth falls within the upper and lower limits during the feedback control period 90, and maintains the welding condition if this predicted value falls within the upper and lower limits. The laser welding apparatus starts the feedback control if the predicted value of the weld penetration depth falls below the lower limit. In this case, since the predicted value of the weld penetration depth is smaller than the target value, the laser welding apparatus causes the weld penetration depth to increase by increasing the laser output. If the predicted value of the weld penetration depth is larger than the target value, the laser welding apparatus causes the weld penetration depth to reduce by reducing the laser output.

The present embodiment is applied to the butt welding, but the joint structure of the welded portion is not limited thereto. Further, the laser type, the material of the welding target object, and the laser welding condition are neither limited to the examples used in the present embodiment. Especially for the butt welding, the weld penetration depth serves as an important factor significantly affecting the welding quality, and the present embodiment can improve the welding quality and improve the yield in the butt welding.

### Second Embodiment

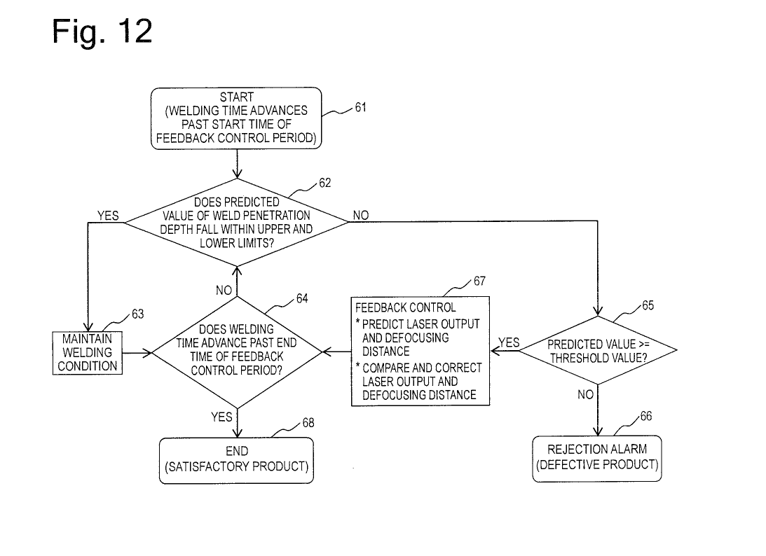

FIG. 12 is a flowchart of feedback control according to a second embodiment. The second embodiment will be described, identifying the same or similar components as or to the first embodiment by the same reference numerals as the first embodiment.

The present second embodiment can be implemented with use of the same laser welding apparatus as the first embodiment. Further, the predicted value of the weld penetration depth is acquired by the method described in the first embodiment. In other words, the second embodiment has a different configuration from the first embodiment in the flow of the feedback control.

In step 61, the flowchart of the feedback control is started when the welding time advances past the start time Ts90 of the feedback control period 90. In step 62, the laser welding apparatus determines whether the predicted value of the weld penetration depth falls within the upper and lower limits (SH3 and SH2). If the determination in step 62 is YES, in step 63, the laser welding apparatus maintains the welding condition. Then, in step 64, the laser welding apparatus determines whether the welding time advances past the end time Te90 of the feedback control period 90. If the determination in step 64 is NO, the processing keeps returning to step 62. If the determination in step 62 is NO, in step 65, the laser welding apparatus determines whether the predicted value is the threshold value SH1 or larger. If the determination in step 65 is NO, in step 66, the laser welding apparatus issues the rejection alarm and determines that this product is the defective product. If the determination in step 65 is YES, the laser welding apparatus performs the feedback control. The laser welding apparatus predicts the laser output and the defocusing distance from the multiple regression analysis based on an experiment result similarly to the weld penetration depth according to the first embodiment. The laser welding apparatus compares the predicted laser output and defocusing distance with the target laser output and defocusing distance, and performs the PID control (proportional-integral-differential control) in such a manner that they match the target values if they are different from the target values. After that, in step 64, the laser welding apparatus determines whether the welding time advances past the end time Te90 of the feedback control period 90. If the determination in step 64 is NO, the processing returns to step 62 and continues. If the determination in step 64 is YES, in step 68, the laser welding apparatus ends the feedback control, and determines that the present product is the satisfactory product.

In the first embodiment, the laser welding apparatus compares the predicted value of the weld penetration depth and the target value thereof, and performs the feedback control in step 57. In the present embodiment, the laser welding apparatus predicts the laser output and the defocusing distance, and compares the predicted values thereof with the target values to perform the feedback control. A similar effect to the first embodiment can also be acquired by such feedback control.

Steps 61 to 66 and 68 in the second embodiment can be performed in a similar manner to steps 51 to 56 and 58 in the first embodiment.

In the first embodiment, the output of the laser 11 (the intensity of the laser 11) is changed by the feedback control. Further, in the second embodiment, the laser output and the defocusing distance (a focal distance) are changed by the feedback control. The laser irradiation condition may be changed by modifying a movement speed of the laser beam 11 relative to the welding target object (an object to be welded) 5 or 5A (a relative speed between the laser beam 11 and the welding target object 5 or 5A), besides the laser output and the defocusing distance. The movement speed of the laser beam 11 relative to the welding target object 5 or 5A can be changed by modifying a rotational speed of the welding target object 5 or 5A. Alternatively, the movement speed of the laser beam 11 relative to the welding target object 5 or 5A can be changed by modifying a speed of the scanning of the laser 11 that defines the circle. Alternatively, the movement speed of the laser beam 11 relative to the welding target object 5 or 5A can be changed by modifying both the rotational speed of the welding target object 5 or 5A and the scanning speed of the laser 11.

In this manner, in each of the first and second embodiments of the present invention, the laser irradiation condition (the irradiation condition of the high-energy beam) such as the laser output, the defocusing distance, or the movement speed of the welding target object is changed by the feedback control. The laser irradiation condition or a correction amount (a control amount) thereof is calculated by the control device 21. In other words, the control device 21 forms a feedback control portion 21D that controls the high-energy beam irradiation apparatus by outputting the correction amount. Alternatively, the control device 21 includes the feedback control portion 21D that controls the high-energy beam irradiation apparatus by outputting the correction amount

It is effective to configure the above-described feedback control portion to prioritize the control of the laser output value (the output value of the high-energy beam) among the above-described laser irradiation conditions. The laser output value, i.e., the laser intensity can be simply and quickly controlled among the other laser irradiation conditions. The feedback control can be easily and quickly performed.

### Third Embodiment

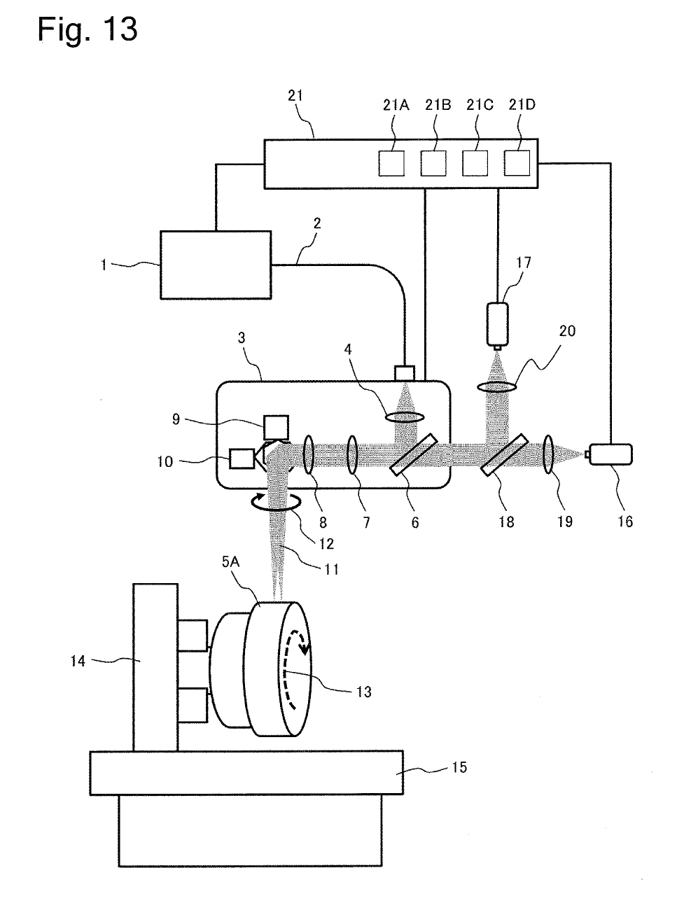

FIG. 13 is a schematic view of a laser welding apparatus according to a third embodiment.

The third embodiment will be described, identifying the same or similar components as or to the first embodiment by the same reference numerals as the first embodiment. Descriptions of the same components as the first embodiment will be omitted below.

The third embodiment is different from the first embodiment in terms of a welding target object 5A. Other features are the same as the first embodiment. A fuel injection component is processed as the welding target object 5A. A lap (or stack) welding structure is created as a welding joint of the welding target object 5A.

The present third embodiment is applied to the lap welding, but the joint structure of the welded portion is not limited thereto. Further, the laser type, the material of the welding target object, and the laser welding condition are neither limited to the examples used in the present third embodiment.

Further, the feedback control described in the second embodiment may be applied to the third embodiment.

### Fourth Embodiment

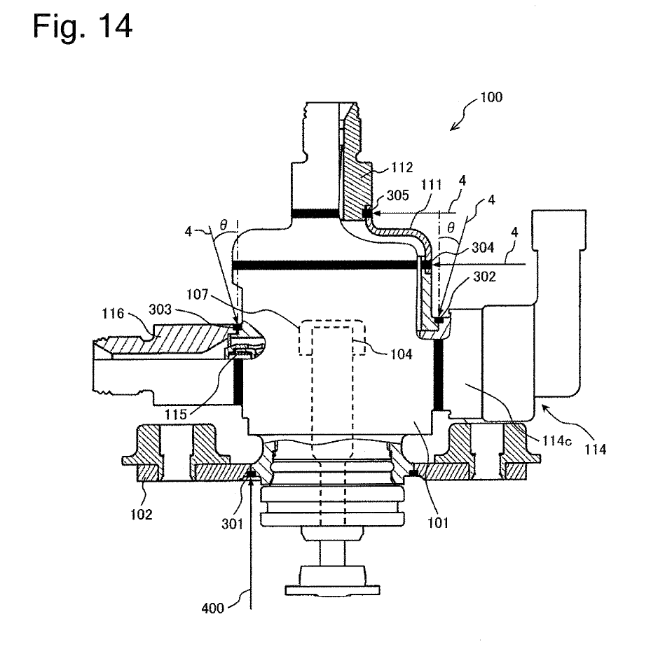

A fourth embodiment is an example in which the welding method according to the present invention is applied to a high-pressure fuel supply pump. FIG. 14 is a cross-sectional view illustrating one embodiment of a fuel pump according to the present invention.

A high-pressure fuel supply pump 100 is a pump that increases a pressure of fuel sucked from a fuel tank by a feed pump (not illustrated) and supplies this fuel to a fuel injection valve. The high-pressure fuel supply pump 100 is used for an internal combustion engine (an engine) mounted on a vehicle. Hereinafter, the high-pressure fuel supply pump 100 will be described while being referred to as a pump 100. A pressure increase chamber 107 is formed in a pump main body 101, and an upper end portion (a distal end portion) of a plunger 104 is inserted inside the pressure increase chamber 107. The plunger 104 reciprocates in the pressure increase chamber 107, thereby increasing the pressure of the fuel.

The pump main body (a pump housing) 101 includes an attachment flange 102 for fixation to the engine. The attachment flange 102 is welded to be joined to the pump main body 101 along an entire circumference thereof by the laser welding. A welded portion 301 at which the attachment flange 102 and the pump main body 101 are welded together will be referred to as a first welded portion.

An intake valve mechanism 114 and a discharge valve mechanism 115 are provided to the pump main body 101. A body 114c of the intake valve mechanism 114 is fixed to the pump main body 101 by the laser welding. This welded portion 302 will be referred to as a second welded portion. At the second welded portion 302, an outer periphery of the body 114c of the intake valve mechanism 114 is welded along an entire circumference.

A discharge joint 116 is provided on a downstream side of the discharge valve mechanism 115. The discharge joint 116 is fixed to the pump main body 101 by the laser welding. This welded portion 303 will be referred to as a third welded portion. At the third welded portion 303, an outer periphery of the discharge joint 116 is welded along an entire circumference.

A damper 111 is attached on an upper portion of the pump main body 101. The damp cover 111 is fixed to the pump main body 101 by the laser welding. This welded portion 304 will be referred to as a fourth welded portion. The fourth welded portion 304 is welded along an entire circumference.

An intake joint 112 is fixed to the damper cover 111 by the laser welding. This welded portion 305 will be referred to as a fifth welded portion. At the fifth welded portion 305, an outer periphery of the intake joint 112 is welded along an entire circumference.

Welding joints of the first welded portion 301, the second welded portion 302, and the third welded portion 303 are butt welding structures, and the first welded portion 301, the second welded portion 302, and the third welded portion 303 are welded by the welding process according to the first embodiment. The first welded portion 301 is irradiated with the laser 11 incident perpendicularly to a surface of the welding target object. The second welded portion 302 and the third welded portion 303 are irradiated with the laser 11 tilted by 0 degrees from a direction perpendicular to the surface of the welding target surface.

Welding joints of the fourth welded portion 304, and the fifth welded portion 305 are lap welding structures, and the fourth welded portion 304 and the fifth welded portion 305 are welded by the welding process according to the third embodiment. The fourth welded portion 304 and the fifth welded portion 305 are irradiated with the laser 11 incident perpendicularly to the surface of the welding target object.

In the pump 100, a fuel leak is not permissible. The pump main body 101, the body 114c of the intake valve mechanism 114, the discharge joint 116, the damper cover 111, and the intake joint 112 are components forming a fuel passage through which the fuel flows. Then, the second welded portion 302 to the fifth welded portion 305 also serve as seals for the fuel. Therefore, it is desirable to sufficiently secure the weld penetration depth for the welding of the component forming the fuel passage. Further, it is assumed that the pump 100 is used under a strict environment. Reliability of the pump 100 can be enhanced by using a highly robust welding process.

### Fifth Embodiment

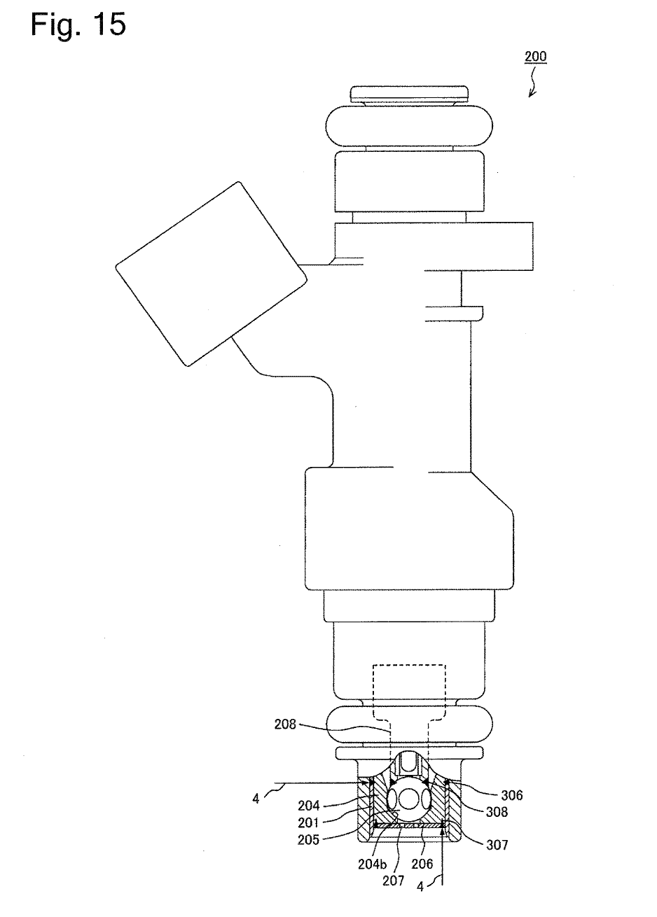

FIG. 15 illustrates a fifth embodiment in which the present invention is applied to a fuel injection valve 200. FIG. 15 is a cross-sectional view illustrating one embodiment of a fuel injection valve according to the present invention.

A tubular body 201 made from a metallic material is provided to the fuel injection valve 200. The tubular body 201 is disposed so as to extend from an upper end portion to a lower end portion of the fuel injection valve 200. A valve seat member 204 is provided at a distal end portion of the tubular body 201. A conical surface is formed on the valve seat member 204, and a valve seat 204b is formed on this conical surface.

The valve seat member 204 is inserted inside a distal end frame of the tubular body 201, and fixed to the tubular body 201 by the laser welding. This welded portion 306 will be referred to as a sixth welded portion. The sixth welded portion 306 is welded along an entire circumference from an outer peripheral side of the tubular body 201.

A nozzle plate 206 is attached to a lower end surface (a distal end surface) of the valve seat member 204. A plurality of fuel injection holes 207 is provided on the nozzle plate 206. The nozzle plate 206 is fixed to the valve seat member 204 by the laser welding. This welded portion 307 will be referred to as a seventh welded portion 307. The seventh welded portion 307 is formed so as to surround an injection hole formation region, in which the fuel injection holes 207 are formed, all around a circumference thereof.

A movable member 208 is contained in the tubular body 201. A valve body 205 is fixed to a distal end of the movable member 208. The valve body 205 is formed by a spherical ball valve. The valve body 205 is fixed to the movable member 208 by the laser welding. This welded portion 308 will be referred to as an eighth welded portion 308. The eighth welded portion 308 is welded along an entire circumference of an outer periphery of the distal end portion of the movable member 208.

The valve body 205 and the valve seat 204b opens and closes the fuel passage in cooperation with each other. The fuel passage is closed by abutment of the valve body 205 against the valve seat 204b. Further, the fuel passage is closed by separation of the valve body 205 from the valve seat 204b. The fuel delivered through the fuel passage between the valve body 205 and the valve seat 204b is injected from the fuel injection holes 207.

Welding joints of the sixth welded portion 306 and the seventh welded portion 307 are lap welding structures, and the sixth welded portion 306 and the seventh welded portion 307 are welded by the welding process according to the third embodiment. The sixth welded portion 306 and the seventh welded portion 307 are irradiated with the laser 11 incident perpendicularly to the surface of the welding target object. The seventh welded portion 307 may be irradiated with the laser 11 tilted from the direction perpendicularly to the surface of the welding target object.

A welding joint of the eighth welded portion 308 is a butt welding structure, and the eighth welded portion 308 is welded by the welding process according to the first embodiment. The eighth welded portion 308 is irradiated with the laser 11 incident perpendicularly to the surface of the welding target object. Alternatively, the eighth welded portion 308 may be irradiated with the laser 11 tilted from the direction perpendicularly to the surface of the welding target object.

In the fuel injection valve 200, a fuel leak is not permissible. The tubular body 201, the valve seat member 204, and the nozzle plate 206 are components forming the fuel passage through which the fuel flows. Then, the sixth welded portion 306 and the seventh welded portion 307 also serve as seals for the fuel. Therefore, it is desirable to sufficiently secure the weld penetration depth. Further, it is assumed that the fuel injection valve 200 is used under a strict environment. Reliability of the fuel injection valve 200 can be enhanced by using a highly robust welding process.

Further, the valve body 205 repeatedly hits the valve seat 204b over a long period of time. For this reason, the welding between the valve body 205 and the movable element 208 at the eighth welded portion 308 should achieve reliability that allows the welded portion to be kept in a stable state over a long period of time. The reliability of the welded portion can be secured by employing the welding process according to the present invention.

The present invention is not limited to each of the above-described embodiments, and includes various modifications. For example, the above-described embodiments have been described in detail to facilitate better understanding of the present invention, and the present invention is not necessarily limited to the configuration including all of the features. Further, a part of the configuration of some embodiment can be replaced with the configuration of another embodiment, and some embodiment can also be implemented with a configuration of another embodiment added to the configuration of this embodiment. Further, each of the embodiments can also be implemented with another configuration added, deleted, or replaced with respect to a part of the configuration of this embodiment.

Having described merely several embodiments of the present invention, it is apparent to those skilled in the art that the embodiments described as the examples can be modified or improved in various manners without substantially departing from the novel teachings and advantages of the present invention. Therefore, such a modified or improved embodiment is intended to be also contained in the technical scope of the present invention.

The present application claims priority under the Paris Convention to Japanese Patent Application No. 2016-054909 filed on Mar. 18, 2016. The entire disclosure of Japanese Patent Application No. 2016-054909 filed on Mar. 18, 2016 including the specification, the claims, the drawings, and the abstract is incorporated herein by reference in its entirety.

The entire disclosures of Japanese Patent Application Public Disclosure No. 2006-43741 (PTL 1) and Japanese Patent Application Public Disclosure No. 2005-14027 (PTL 2) including the specifications, the claims, the drawings, and the abstracts are incorporated herein by reference in their entirety.

### Reference Signs List

1 laser oscillator

2 laser optical fiber

3 galvano scanner

4 collimator lens

5 welding target object

5A welding target object

6 partial wavelength transmissive mirror

7 Z-axis control lens

8 objective lens

9 X-axis control galvano mirror

19 Y-axis control galvano mirror

11 laser

12 direction in which the laser rotates

13 direction in which the welding target object rotates

14 rotary spindle

15 processing stage

16 camera

17 welding optical sensor

18 semi-transmissive mirror

19 objective lens for the camera

29 objective lens for the welding optical sensor

21 control device

22 molten pool

23 laser irradiation point

24 movement track of the laser irradiation point in the molten pool

25 X axis in an image as viewed from a viewpoint moving in a welding progress direction

26 Y axis in the image as viewed from the viewpoint moving in the welding progress direction

27 welding progress direction

28 X axis in an image in which the laser irradiation point is placed at an origin point

29 Y axis in the image in which the laser irradiation point is placed at the origin point

30 sputter

31 horizontal line on an image in which a luminance is measured.

32 luminance distribution on the horizontal line 31

33 distribution of a value resulting from summing luminances on the Y axis (projection value)

34 line of a threshold value for detecting a start point and an end point of the molten pool based on the projection value

35 rectangle circumscribed to the molten pool

36 threshold value for determining a quality of welding with respect to an actually measured value

37 threshold value for determining the quality of the welding with respect to a predicted value in consideration of an error

38 distribution of a value resulting from summing luminances on the X axis (projection value)

39 line of a threshold value for detecting a position of the molten pool in a Y-axis direction based on the projection value

90 feedback control period of the welding

91 upward slope period of a laser output

92 actual welding period

93 welding lap portion

94 downward slope period of the laser output

100 high-pressure fuel supply pump

101 pump main body

102 attachment flange

111 damper cover

112 intake joint

114 intake valve mechanism

114c body of the intake valve mechanism 114

116 discharge joint

200 fuel injection valve

201 tubular body

204 valve seat member

206 nozzle plate

301 first welded portion

302 second welded portion

303 third welded portion

304 fourth welded portion

305 fifth welded portion

306 sixth welded portion

307 seventh welded portion

308 eighth welded portion

1. A method for determining a quality of high-energy beam welding that welds a welding target object by irradiating the welding target object with a high-energy beam, the method for determining the quality of the high-energy beam welding comprising:
acquiring a predicted value of a weld penetration depth of a molten pool based on
shape information of the molten pool that is detected by performing image processing on an image of the molten pool captured by a camera,
welding optical sensor information including plasma light that is detected by a welding optical sensor, and
a partial regression analysis coefficient acquired by carrying out a multiple regression analysis with the weld penetration depth of the molten pool set as an objective variable and the shape information and the welding optical sensor information set as explanatory variables; and
determining the quality of the welding by comparing the predicted value and a reference value.

2. The method for determining the quality of the high-energy beam welding according to claim 1, wherein the welding optical sensor information includes reflected light and thermal irradiation light.

3. The method for determining the quality of the high-energy beam welding according to claim 2, wherein an interaction acquired by multiplying one piece of information included in the shape information and one piece of information included in the welding optical sensor information is added to the explanatory variables.

4. The method for determining the quality of the high-energy beam welding according to claim 1, wherein the partial regression analysis coefficient is acquired by conducting an experiment in advance.

5. The method for determining the quality of the high-energy beam welding according to claim 1, wherein the method is used for a welding target object, a welding joint of which is a butt structure.

6. The method for determining the quality of the high-energy beam welding according to claim 1, further comprising irradiating the welding target object with the high-energy beam while rotating the high-energy beam.

7. An apparatus configured to determine a quality of high-energy beam welding that welds a welding target object by irradiating the welding target object with a high-energy beam, the apparatus configured to determine the quality of the high-energy beam welding comprising:
a molten pool shape information detection portion configured to detect shape information of a molten pool by performing image processing on an image of the molten pool that is captured by a camera;
a welding optical sensor configured to detect welding optical sensor information including plasma light;
a partial regression analysis coefficient storage portion configured to store a partial regression analysis coefficient acquired by carrying out a multiple regression analysis with the weld penetration depth of the molten pool set as an objective variable and the shape information and the welding optical sensor information set as explanatory variables;
a predicted value calculation portion configured to acquire a predicted value of the weld penetration depth of the molten pool based on the molten pool shape information, the welding optical sensor information, and the partial regression analysis coefficient; and
a quality determination portion configured to determine the quality of the welding by comparing the predicted value and a reference value.

8. The apparatus configured to determine the quality of the high-energy beam welding according to claim 7, wherein the welding optical sensor information includes reflected light and thermal irradiation light.

9. The apparatus configured to determine the quality of the high-energy beam welding according to claim 8,
wherein the predicted value calculation portion includes a multiple regression analysis portion configured to acquire the partial regression analysis coefficient by carrying out the multiple regression analysis with the molten pool shape information, the welding optical sensor information, and the weld penetration depth of the molten pool set as objective variables and the shape information and the welding optical sensor information set as the explanatory variables, and
wherein an interaction acquired by multiplying one piece of information included in the shape information and one piece of information included in the welding optical sensor information is added to the explanatory variables.

10. The apparatus configured to determine the quality of the high-energy beam welding according to claim 9, wherein the apparatus is used for a welding target object, a welding joint of which is a butt structure.

11. The apparatus configured to determine the quality of the high-energy beam welding according to claim 7, wherein the molten pool is formed by irradiating the welding target object with the high-energy beam while rotating the high-energy beam.

12. A welding management system for high-energy beam welding, comprising:
a high-energy beam irradiation apparatus configured to weld a welding target object by irradiating the welding target object with a high-energy beam;
a camera configured to capture an image of a molten pool;
a molten pool shape information detection portion configured to detect shape information of the molten pool by performing image processing on the image of the molten pool that is captured by the camera;
a welding optical sensor configured to detect welding optical sensor information including plasma light;
a partial regression analysis coefficient storage portion configured to store a partial regression analysis coefficient acquired by carrying out a multiple regression analysis with the weld penetration depth of the molten pool set as an objective variable and the shape information and the welding optical sensor information set as explanatory variables;
a predicted value calculation portion configured to acquire a predicted value of the weld penetration depth of the molten pool based on the molten pool shape information, the welding optical sensor information, and the partial regression analysis coefficient;
a quality determination portion configured to determine a quality of the welding by comparing the predicted value and a reference value; and
a feedback control portion configured to output a correction value for correcting an irradiation condition of the high-energy beam based on a result of the comparison between the predicted value and the reference value, and perform feedback control on the high-energy beam output by the high-energy beam irradiation apparatus.

13. The welding management system for the high-energy beam welding according to claim 12, wherein, when Kp, Ki, and Kd represent a proportional control coefficient, an integral control coefficient, and a differential control coefficient, respectively, the correction value is acquired from the following relation expression,
(the correction value)=(a previous output value)+Kp×(a deviation)+Ki×(a cumulative value of the deviation)+Kd×(a difference between a present deviation and a previous deviation).

14. The welding management system for the high-energy beam welding according to claim 13, wherein the feedback control portion prioritizes control of an output value of the high-energy beam.

15. The welding management system for the high-energy beam welding according to claim 12, wherein the feedback control portion controls an intensity of the high-energy beam.

16. The welding management system for the high-energy beam welding according to claim 12, wherein the feedback control portion controls a focal length of the high-energy beam.

17. The welding management system for the high-energy beam welding according to claim 12, wherein the feedback control portion controls a movement speed of the high-energy beam relative to the welding target portion.
